(19) United States
(12) Patent Application Publication
(10) Pub. No.: US 2026/0264100 A1
(43) Pub. Date: Sep. 10, 2026

(54) LOCKING STRUCTURE FOR PRODUCT DISPENSER

(71) Applicant: ELC MANAGEMENT LLC, Melville, NY (US)

(72) Inventor: Hervé Georges Buzot, Mendham, NJ (US)

(21) Appl. No.: 19/073,539

(22) Filed: Mar. 7, 2025

(51) Int. Cl. B05B 11/10

(52) U.S. Cl. CPC B05B 11/1059

(57) ABSTRACT

A product dispenser includes a container, an actuator, a pump, a locking structure, and a collar. The container has an enclosed volume for a product, and the actuator is in fluid communication with the enclosed volume and has a nozzle for dispensing the product when the pump is actuated by compression of the actuator. The locking structure includes a ring positioned around the container and a locking projection extending from the ring, and the collar has a channel between an exterior wall and an interior wall. The locking projection of the locking structure is rotatably secured within the channel of the collar and is rotatable between a locked position below the nozzle of the actuator and an unlocked position offset from below the nozzle of the actuator.

### FIELD OF THE DISCLOSURE

The present disclosure generally relates to a product dispenser that can be locked to prevent actuation. More specifically, the present disclosure relates to a product dispenser including a locking structure that is separate from the actuator and locks via engagement with an actuator of the product dispenser.

### BACKGROUND

Lockable product dispensers often lock via a rotating actuator. Further, lockable product dispensers often have a locking component positioned under the base of the main body of their actuator.

### SUMMARY

Examples within the scope of the present disclosure are directed to a locking mechanism for a product dispenser.

In an example, a product dispenser includes a container, an actuator, a pump, and a locking structure. The container has an enclosed volume for a product. The actuator is in fluid communication with the enclosed volume. The actuator has a main body and a nozzle. The pump has a fluid pathway positioned between the actuator and the container, and the pump is configured to be actuated by compression of the actuator to move product from the enclosed volume to the actuator. The locking structure includes a ring positioned around the container and a locking projection extending from the ring. . The locking projection of the locking structure is rotatable between a locked position below the nozzle of the actuator and an unlocked position offset from below the nozzle of the actuator.

In an approach, the product dispenser may include a collar having an exterior wall, an interior wall secured to the container, and a channel between the exterior wall and the interior wall. The locking projection may be rotatably secured within the channel of the collar.

In an approach, the collar may include a button recess in the exterior wall, and the locking structure may include a locking button extending from the ring and positioned in the button recess.

In an approach, the button recess may have a first side and a second side. The locking projection may be positioned in the locked position when the locking button is adjacent the first side, and the locking projection may be positioned in an unlocked position when the locking button is adjacent the second side.

In an approach, the interior wall of the collar may include an outward-facing raised area aligned with the button recess of the exterior wall between the first side and the second side. The outward-facing raised area may be configured to provide feedback when the locking projection rotates between an unlocked position and a locked position.

In an approach, the ring may include an inward-facing raised area extending from the ring opposite the locking button. The inward-facing raised area may be configured to provide feedback when the locking projection rotates between an unlocked and a locked position.

In an approach, the ring may include an inward-facing raised area extending from the ring opposite the locking button, and the inward-facing raised area may engage the outward-facing raised area when the locking projection rotates between an unlocked and a locked position.

In an approach, mobility of the locking structure may be limited when the locking projection is in a locked position by engagement between the locking button and the first side of the button recess and by engagement between the outward-facing raised area and the inward-facing raised area.

In an approach, the main body may be slidably positioned adjacent to the interior wall of the collar.

In an approach, the container may include a threaded neck, the interior wall of the collar may include interior threads, and the collar may be threadably connected to the threaded neck of the container by the interior threads.

In an approach, the interior wall of the collar may include an interior actuator recess and the exterior wall of the collar may include an exterior actuator recess aligned with the interior actuator recess so that the nozzle of the actuator can be compressed when the locking projection is in the unlocked position.

In an approach, the exterior wall of the collar may include a recessed groove, and the ring of the locking structure may include a convex surface. The convex surface of the ring may be positioned within the recessed groove of the exterior wall.

In an approach, the exterior wall of the collar may include a bottom surface, and the ring of the locking structure may include an upward-facing surface. The upward-facing surface of the ring may be positioned next to the bottom surface of the collar.

In an approach, the product dispenser may have a longitudinal axis along which the actuator is compressed, and the interior wall of the collar may include a dividing wall substantially perpendicular to the longitudinal axis. The dividing wall may limit compression of the actuator.

In an approach, the exterior wall of the collar may include a bottom surface and the interior wall of the collar may include a lower surface offset from the bottom surface. The ring of the locking structure may include a curved surface that extends from the lower surface to the bottom surface when the locking structure is positioned within the collar.

In an approach, the interior wall of the collar may include an interior finger recess and the exterior wall of the collar may include an exterior finger recess aligned with the interior finger recess. A compression surface may extend between the interior finger recess of the interior wall and the exterior finger recess of the exterior wall.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples. Also, common but well-understood elements that are useful or necessary in a commercially feasible examples are often not depicted to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### BRIEF DESCRIPTION OF THE DRAWINGS

The figures described below depict various aspects of the system and methods disclosed herein. It should be understood that each figure depicts an arrangement of a particular aspect of the disclosed system and methods, and that each of the figures is intended to accord with a possible arrangement thereof.

There are shown in the drawings arrangements which are presently discussed, it being understood, however, that the present embodiments are not limited to the precise arrangements and instrumentalities shown, wherein:

FIG. 1A illustrates a product dispenser in a locked configuration.

FIG. 1B illustrates the product dispenser of FIG. 1A in an unlocked configuration.

FIG. 2 illustrates the product dispenser of FIGS. 1A and 1B in an unlocked configuration with a collar removed to show a locking projection of the locking structure offset from an actuator.

FIG. 3 illustrates the product dispenser of FIGS. 1A-2 with the locking button of the locking structure extending through a button recess of the collar.

FIG. 4 is an exploded view of an upper portion of the product dispenser of FIGS. 1-3.

FIG. 5A is a cross-sectional view of the product dispenser of FIGS. 1-3 in an unlocked configuration with the pump and actuator of the product dispenser depicted schematically.

FIG. 5B is a partial cross-sectional view of the product dispenser of FIGS. 1-5A in a locked configuration.

FIG. 6 is a cross-sectional view of the actuator of the product dispenser of FIGS. 1-5B.

FIG. 7A is a top perspective view of the collar of the product dispenser of FIGS. 1-5B.

FIG. 7B is a cross-sectional view of the collar of FIG. 7A.

FIG. 7C is a bottom perspective view of the collar of FIGS. 7A and 7B.

FIG. 8A is a top perspective view of an alternate collar having a single wall.

FIG. 8B is a cross-sectional view of the alternate collar of FIG. 8A.

FIG. 9A is a top perspective view of the locking structure of the product dispenser of FIGS. 1-5B, including the locking projection, a ring, and a locking button.

FIG. 9B is a cross-sectional view of the locking structure of FIG. 9A.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples. Also, common but well-understood elements that are useful or necessary in a commercially feasible examples are often not depicted to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various approaches, a product dispenser is provided with a locking structure to selectively prevent a product dispenser from dispensing a product during periods of non-use. The locking structure includes a locking projection that can be positioned directly below a nozzle of the actuator to prevent the actuator from being compressed, thereby preventing actuation of a pump of the product dispenser. The locking structure further includes a ring that can be secured around a container of the product dispenser in a manner that allows free rotation of the locking structure. The product dispenser includes a collar in which the locking projection moves. The collar has an actuator recess below the actuator of the product dispenser that allows the actuator to be compressed to actuate the product dispenser, and the locking projection is moved to physically impede compression of the actuator within the actuator recess when in the locking configuration. The locking structure includes a locking button extending outward from the ring, and the collar includes a button recess through which the locking button extends. A user can move the locking structure from a locked configuration to an unlocked configuration, or vice versa, by moving the locking button within the button recess. The locking structure, collar, and product dispenser as a whole is user-friendly. The visibility or lack thereof of the locking projection in the actuator recess indicates to a user that the product dispenser is locked or unlocked, and the locking button is a straightforward way to lock or unlock the product dispenser. Tactile and/or auditory feedback may also be provided when the locking button rotates to indicate to a user that the product dispenser is locked or unlocked.

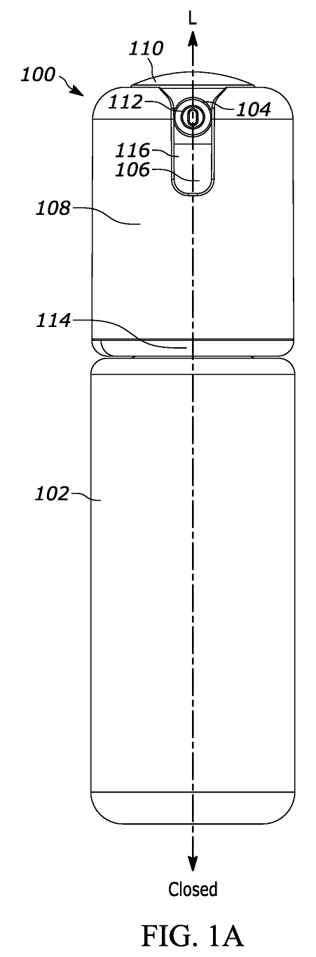

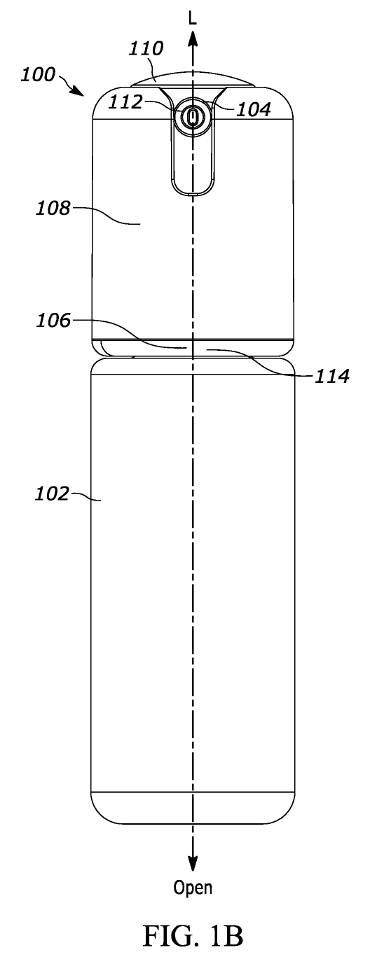

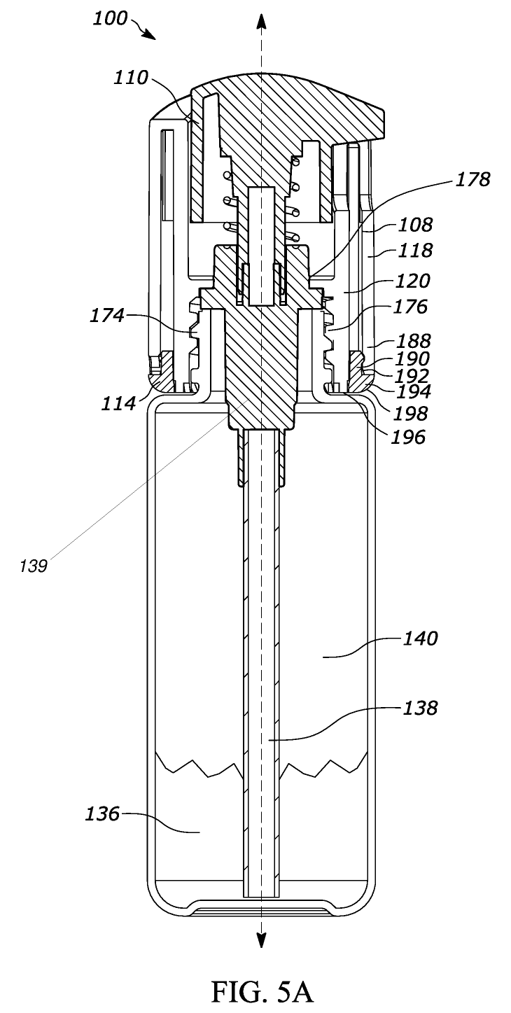

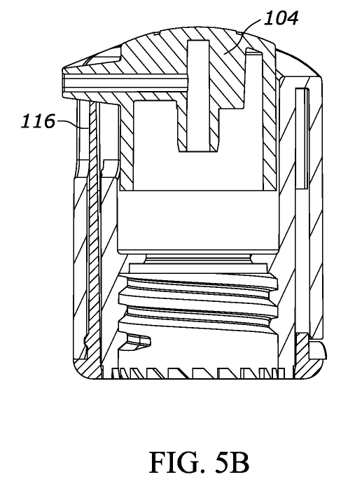

FIGS. 1A and 1B illustrates a product dispenser 100 in, respectively, a locked configuration and an unlocked configuration. As shown, the product dispenser 100 includes a container 102, an actuator 104, a locking structure 106, and a collar 108, which are all arranged along a longitudinal axis L. The actuator 104 has a main body 110 positioned on the longitudinal axis L and a nozzle 112 that extends from the main body 110. The main body 110 includes a top surface or finger pad for pressing on the actuator 104. The actuator 104 may be a single integral part or a plurality of parts that are assembled to form the actuator 104. For example, the main body 110 may be a separate component that is connected to the nozzle 112, or the actuator 104 may have a separate top surface that connects to other components of the actuator 104. The locking structure 106 includes a ring 114 positioned around the container 102 and a locking projection 116 extending from the ring (visible in FIG. 1A and hidden behind collar 108 in FIG. 1B). As shown in FIG. 5A, the collar 108 includes an exterior wall 118, an interior wall 120 that is secured to the container 102, and a channel 122 between the exterior wall 118 and the interior wall 120. The locking projection 116 (shown in FIG. 1A and 5B) of the locking structure 106 is rotatably secured within the channel 122 of the collar 108. Returning to FIGS. 1A and 1B, the locking projection 116 rotates from the locked position shown in FIG. 1A in which the locking projection 116 is below the nozzle 112 of the actuator 104, and the unlocked position shown in FIG. 1B where the locking projection 116 is offset from below the nozzle 112 of the actuator 104. The locking projection 116 is not visible in FIG. 1B because it is covered by the collar 108.

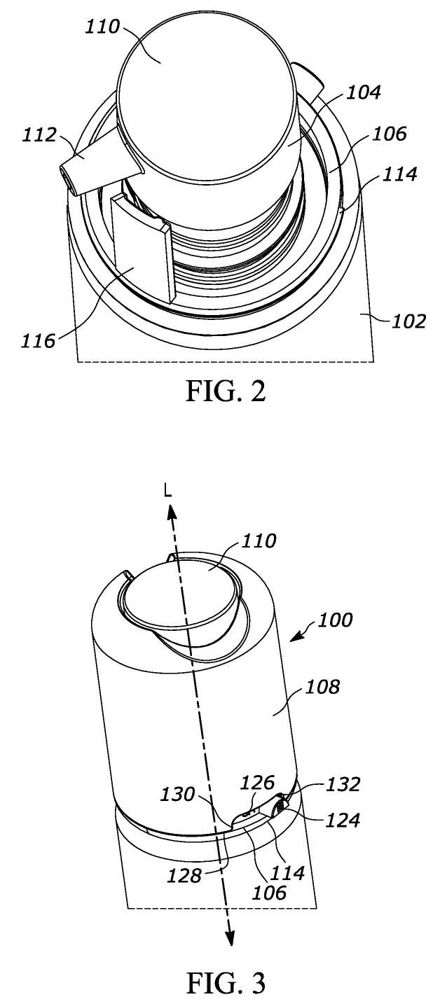

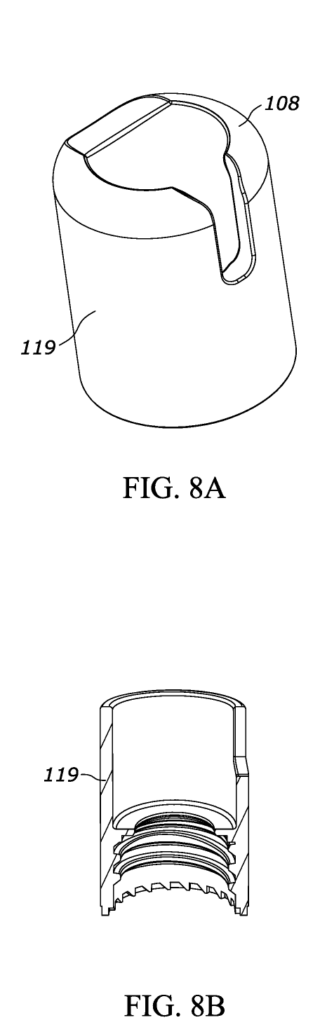

The location of the locking projection 116 in a locked position can be seen in FIG. 2, in which the collar 108 is removed. In some arrangements, the product dispenser 100 may not include a collar 108 such that the locking projection 116 of the locking structure 106 is visible as shown in FIG. 2 as opposed to being within a channel 122. Eliminating the collar may reduce costs associated with manufacture of the product dispenser 100. As another option, a shown in FIGS. 8A and 8B, the collar 108 may include only a single wall 119 that is similar to the interior wall 120, thereby reducing material expenses and complexity while still providing some aesthetic and protective purposes. In such an arrangement, the locking projection 116 is visible during rotation between the locked position and the unlocked position. While the full collar 108 may be desirable for sale of higher end products, such as designer cosmetics, eliminating the collar 108 or using a version of the collar 108 that includes only the interior wall 120 may be desirable for lower cost products, such as cleaning supplies, whose sale is less dependent on aesthetics.

FIG. 3 illustrates the product dispenser 100 with a locking button 124 of the locking structure 106 extending from the ring 114 and positioned in a button recess 126 of the collar 108. In the arrangement shown, the button recess 126 is at a bottom edge 128 of the collar 108. The button recess has a first side 130 and a second side 132. The locking projection 116 is positioned in the locked position when the locking button 124 is adjacent the first side 130 (as shown in FIG. 1A), and the locking projection 116 is positioned in the unlocked position with the locking button 124 is adjacent the second side 132 (as shown in FIG. 2).

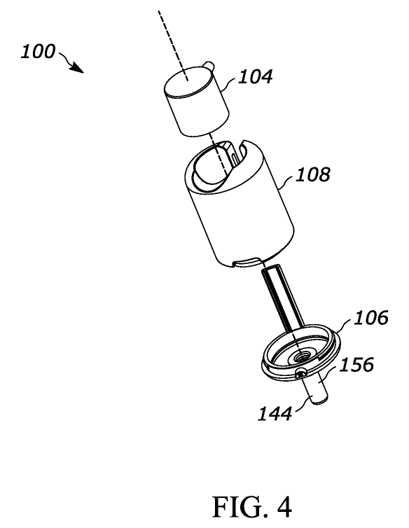

FIG. 4 is an exploded view of the upper portion of the product dispenser 100 illustrating the actuator 104, collar 108, and locking structure 106. Turning to FIG. 5A, the product dispenser 100 includes a pump 139 that is actuated by compression of the actuator 104 to move the product 136 from an enclosed volume 140 of the container 102 to the actuator 104. The pump 139 is illustrated schematically in FIG. 5A as a variety of pump designs are known in the art. While shown as a single component 139, the pump 139 may include a plurality of components. The pump 139 may be connected to a tube 138 that transfers the product 136 from the enclosed volume 140 to the pump 139. In the arrangement shown in FIG. 5A, the actuator 104 is also depicted schematically to include intermediate components that would typically not be formed integrally with the actuator 104 but facilitate engagement between the actuator 104 and the pump 139. Relative movement between the actuator 104 and the pump 139 actuates the pump 139.

As shown in FIG. 5A, the product dispenser 100 contains a product 136. For example, the product 136 may be a cosmetic such as a foundation, blush, tinted moisturizer, bronzer, eye shadow, may be a cleaning agent such as hand soap or shampoo, or may be a skincare or haircare product. The product 136 may be a household product, such as dish soap, hand sanitizer, all-purpose cleaner, glass cleaner, furniture polish, detergent, fabric softener, or an air freshener. The product 136 may be a medical or health product, such as an antiseptic gel, a medicated cream or ointment, cough syrup, or sunscreen. The product 136 may be a food or a beverage, such as a liquid sweetener, oil or vinegar, a condiment sauce such as ketchup, or a creamer. Other products 136 are also possible.

As shown in FIG. 5A, the container 102 includes a neck 174 that is threaded, and the interior wall 120 of the collar 108 includes interior threads 176. The collar 108 is threadably connected to the threaded neck 174 of the container 102 by the interior threads 176. In other arrangements, the neck 174 may not be threaded, and the collar 108 may be connected to the neck 174 by an alternate means, such as a press fit. The interior wall 120 of the collar 108 includes a dividing wall 178 substantially perpendicular to the longitudinal axis L. The main body 110 is slidably positioned adjacent to the interior wall 120 of the collar 108, and the dividing wall 178 limits compression of the actuator 104.

As shown in FIG. 5A, the exterior wall 118 of the collar 108 includes a recessed groove 188, and the ring 114 of the locking structure 106 includes a convex surface 190 that is positioned within the recessed groove 188. This engagement keeps the locking structure 106 connected to the collar 108 while still allowing the locking structure 106 to rotate relative to the collar 108. The exterior wall 118 of the collar 108 includes a bottom surface 192, and the ring 114 of the locking structure 106 includes an upward-facing surface 194. The upward-facing surface 194 is positioned next to the bottom surface 192. The interior wall 120 of the collar 108 includes a lower surface 196 that is offset along the longitudinal axis L from the bottom surface 192, and the ring 114 of the locking structure 106 includes a curved surface 198 that extends from the lower surface 196 to the bottom surface 192 when the locking structure 106 is positioned within the collar 108. Specifically, the curved surface 198 is a convex surface between the lower surface 196 and the bottom surface 192 that eliminates areas where debris or dust might otherwise accumulate and provides an ergonomic shape that is comfortable for a user when holding the product dispenser 100. FIG. 5A illustrates the locking structure 106 in an unlocked position, whereas FIG. 5B illustrates the locking structure 106, and specifically the locking projection 116, in a locked position.

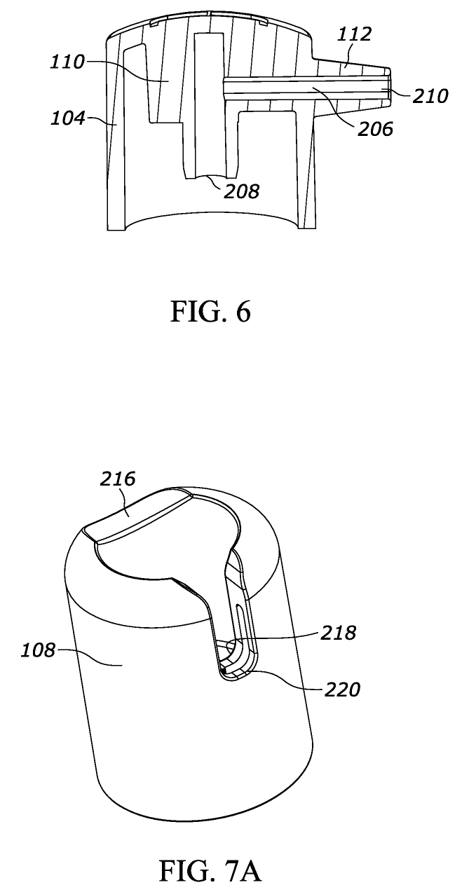

FIG. 6 illustrates the actuator 104. The actuator 104 has an actuator pathway 206 through which the product 136 flows after traveling through the pump 139. The actuator pathway 206 has an ingress 208 that receives product 136 when the actuator 104 is compressed. The actuator pathway 206 has an egress 210 in the nozzle 112 through which the product 136 exits the actuator 104. The main body 110 is substantially annular.

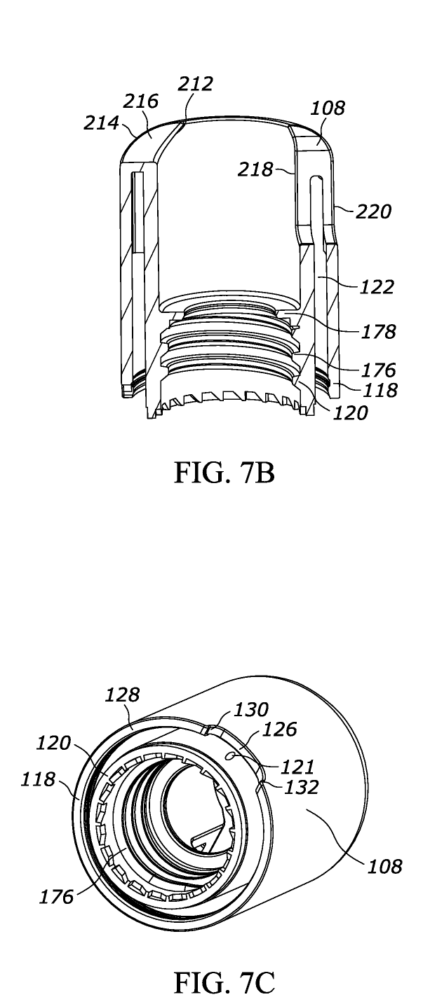

FIGS. 7A-C illustrate the collar 108. FIG. 7B illustrates the dividing wall 178 and interior threads 176 discussed above. The interior wall 120 of the collar 108 includes an interior finger recess 212. The exterior wall 118 of the collar includes an exterior finger recess 214 aligned with the interior finger recess 212, and a compression surface 216 extends between the interior finger recess 212 of the interior wall 120 and the exterior finger recess 214 of the exterior wall 118 across the channel 122. The interior wall 120 of the collar 108 includes an interior actuator recess 218. The exterior wall 118 of the collar 108 includes an exterior actuator recess 220 aligned with the interior actuator recess 218 so that the nozzle 112 of the actuator 104 can be compressed when the locking projection 116 is in the unlocked position.

FIG. 7C illustrates the button recess 126 in the exterior wall 118. As discussed above, the button recess 126 is at a bottom edge 128 and has a first side 130 and a second side 132. The interior wall 120 of the collar 108 includes an outward-facing raised area 121 aligned with the button recess 126 of the exterior wall 118 between the first side 130 and the second side 132. The outward-facing raised area 121 may, for example, be a ridge or bump that extends away from the interior wall 120 and generally toward the exterior wall 118 or the button recess 126 in the exterior wall 118. The outward-facing raised area 121 may be integrated with the interior wall 120 (e.g., by being molded at the same time and from the same material as the interior wall 120) or may separate from and secured to the interior wall 120 (e.g., by adhering a three-dimensional object to the interior wall 120, where the object may be made from the same material as the interior wall 120 or may be a different material such as silicone). The outward-facing raised area 121 is configured to provide feedback when the locking projection 116 rotates between an unlocked position and a locked position. For example, engagement between the outward-facing raised area 121 and the ring 114 may generate a tactile sensation that a user can sense when rotating the ring 114 and/or may provide auditory feedback by generating a sound. Further, the outward-facing raised area 121 may help to secure the locking structure 106 in place by generating friction between the outward-facing raised area 121 and the ring 114 that limits rotation of the ring 114 to only occurring when a user exerts a force that exceeds the force provided by the friction.

FIGS. 8A and 8B illustrate an alternate collar 108 having a single wall 119. Apart from lacking an exterior wall 118, the collar 108 is substantially the same as the collar 108 depicted and described with respect to FIGS. 7A-7C and may include any of the features described in association therewith.

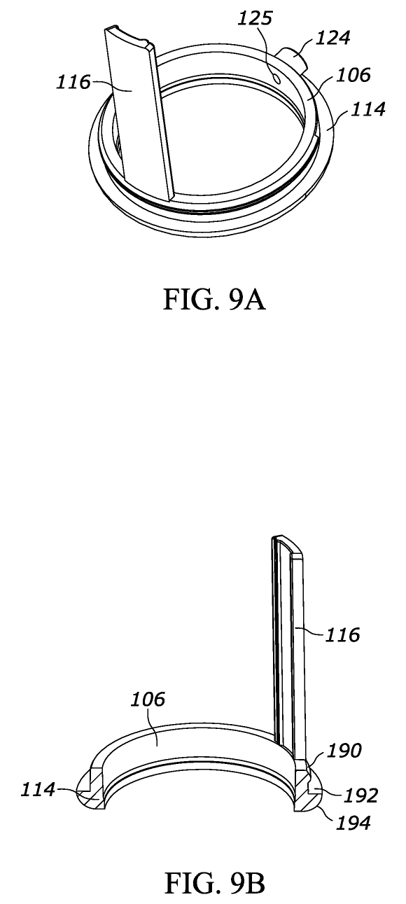

FIGS. 9A and 9B illustrate the locking structure 106, including the locking projection 116, a ring 114, and a locking button 124. Further, FIGS. 9A and 9B illustrate the convex surface 190 of the ring 114, the upward-facing surface 194 of the ring 114, and the curved surface 198 of the ring 114 discussed above. As shown in FIG. 9B, the ring 114 includes an inward-facing raised area 125 extending from the ring 114 opposite the locking button 124. The inward-facing raised area 125 may be provided instead of, or in conjunction with, the outward-facing raised area 121. That is, the product dispenser 100 may have one of the outward-facing raised area 121 and the inward-facing raised area or may have both an outward-facing raised area 121 and an inward-facing raised area 125. The inward-facing raised area 125 may, for example, be a ridge or bump that extends interiorly from the ring 114. The inward-facing raised area 125 may be integrated with the ring 114 (e.g., by being molded at the same time and from the same material as the ring 114) or may separate from and secured to the ring 114 (e.g., by adhering a three-dimensional object to the ring 114, where the object may be made from the same material as the ring 114 or may be a different material such as silicone).

The inward-facing raised area 125 is configured to provide feedback when the locking projection 116 rotates between an unlocked position and a locked position. For example, engagement between the inward-facing raised area 125 and the interior wall 120 of the collar 108 may generate a tactile sensation that a user can sense when rotating the ring 114 and/or may provide auditory feedback by generating a sound. Further, the inward-facing raised area 125 may help to secure the locking structure 106 in place by generating friction between the inward-facing raised area 125 and the interior wall 120 that limits rotation of the ring 114 to only occurring when a user exerts a force that exceeds the force provided by the friction. In arrangements having both an outward-facing raised area 121 and an inward-facing raised area 125, the outward-facing raised area 121 and the inward-facing raised area 125 may engage when the locking projection 116 rotates between an unlocked and a locked position. The mobility of the locking structure 106 is limited when the locking projection 116 is in a locked position by engagement between the locking button 124 and the first side 130 of the button recess 126 and by engagement between the outward-facing raised area 121 and the inward-facing raised area 125. This ensures that the locking projection 116 stays below actuator 104 to perform its locking function.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for cosmetic application, and/or systems, methods, and/or techniques associated therewith. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A product dispenser comprising:
a container having an enclosed volume for a product;
an actuator in fluid communication with the enclosed volume, the actuator having a main body and a nozzle;
a pump having a fluid pathway positioned between the actuator and the container, the pump configured to be actuated by compression of the actuator to move product from the enclosed volume to the actuator; and
a locking structure comprising a ring positioned around the container and a locking projection extending from the ring;
wherein the locking projection of the locking structure is rotatable between a locked position below the nozzle of the actuator and an unlocked position offset from below the nozzle of the actuator.

2. The product dispenser of claim 1 further including a collar having an exterior wall, an interior wall secured to the container, and a channel between the exterior wall and the interior wall, wherein the locking projection of the locking structure is rotatably secured within the channel of the collar.

3. The product dispenser of claim 2, wherein the collar includes a button recess in the exterior wall, and the locking structure includes locking button extending from the ring and positioned in the button recess.

4. The product dispenser of claim 3, wherein the button recess has a first side and a second side, and wherein the locking projection is positioned in the locked position when the locking button is adjacent the first side, and wherein the locking projection is positioned in an unlocked position when the locking button is adjacent the second side.

5. The product dispenser of claim 4, wherein the interior wall of the collar includes an outward-facing raised area aligned with the button recess of the exterior wall between the first side and the second side, the outward-facing raised area configured to provide feedback when the locking projection rotates between an unlocked position and a locked position.

6. The product dispenser of claim 3, wherein the ring includes an inward-facing raised area extending from the ring opposite the locking button, the inward-facing raised area configured to provide feedback when the locking projection rotates between an unlocked and a locked position.

7. The product dispenser of claim 5, wherein the ring includes an inward-facing raised area extending from the ring opposite the locking button, the inward-facing raised area engaging the outward-facing raised area when the locking projection rotates between an unlocked and a locked position.

8. The product dispenser of claim 7, wherein mobility of the locking structure is limited when the locking projection is in a locked position by engagement between the locking button and the first side of the button recess and by engagement between the outward-facing raised area and the inward-facing raised area.

9. The product dispenser of claim 2, wherein the main body is slidably positioned adjacent to the interior wall of the collar.

10. The product dispenser of claim 2, wherein the container includes a threaded neck, and the interior wall of the collar includes interior threads, and the collar is threadably connected to the threaded neck of the container by the interior threads.

11. The product dispenser of claim 2, wherein the interior wall of the collar includes an interior actuator recess and the exterior wall of the collar includes an exterior actuator recess aligned with the interior actuator recess so that the nozzle of the actuator can be compressed when the locking projection is in the unlocked position.

12. The product dispenser of claim 2, wherein the exterior wall of the collar includes a recessed groove, and the ring of the locking structure includes a convex surface, the convex surface of the ring positioned within the recessed groove of the exterior wall.

13. The product dispenser of claim 2, wherein the exterior wall of the collar includes a bottom surface, and the ring of the locking structure includes an upward-facing surface, the upward-facing surface of the ring positioned next to the bottom surface of the collar.

14. The product dispenser of claim 2, wherein the product dispenser has a longitudinal axis along which the actuator is compressed, and the interior wall of the collar includes a dividing wall substantially perpendicular to the longitudinal axis, and wherein the dividing wall limits compression of the actuator.

15. The product dispenser of claim 2, wherein the exterior wall of the collar includes a bottom surface and the interior wall of the collar includes a lower surface offset from the bottom surface, and the ring of the locking structure includes a curved surface that extends from the lower surface to the bottom surface when the locking structure is positioned within the collar.

16. The product dispenser of claim 2, wherein the interior wall of the collar includes an interior finger recess and the exterior wall of the collar includes an exterior finger recess aligned with the interior finger recess, and a compression surface extends between the interior finger recess of the interior wall and the exterior finger recess of the exterior wall.

17. The product dispenser of claim 1, further including a collar having a single wall secured to the container, the locking projection of the locking structure visible during rotation between the locked position and the unlocked position.
